(19) United States
(12) Patent Application Publication
(10) Pub. No.: US 2019/0287107 A1
(43) Pub. Date: Sep. 19, 2019

(54) RESOURCE EQUITY FOR BLOCKCHAIN

(71) Applicant: International Business Machines Corporation, Armonk, NY (US)

(72) Inventors: Nitin Gaur, Roundrock, TX (US); Nikhil E. Gupta, Brooklyn, NY (US)

(21) Appl. No.: 15/922,639

(22) Filed: Mar. 15, 2018

(51) Int. Cl. G06Q 20/40; G06Q 30/04; G06F 17/30

(52) U.S. Cl. CPC G06Q 20/407; G06F 17/30283; G06Q 30/04

(57) ABSTRACT

An example operation may include one or more of receiving, by a blockchain network, a transaction from a user device, submitting bids for validating the transaction to nodes within the blockchain network, from one or more validating nodes, calculating transaction parameters based on the submitted bids, by the one or more validating nodes, validating, by the one or more validating nodes, the transaction; executing, by a node within the blockchain network, the transaction, calculating a chargeback for the transaction, and distributing the chargeback to at least one of the one or more validating nodes.

### TECHNICAL FIELD

This application generally relates to blockchain networks, and more particularly, relates to resource equity for blockchain.

### BACKGROUND

A ledger is commonly defined as an account book of entry, in which transactions are recorded. A distributed ledger is ledger that is replicated in whole or in part to multiple computers. A Cryptographic Distributed Ledger (CDL) can have at least some of these properties: irreversibility (once a transaction is recorded, it cannot be reversed), accessibility (any party can access the CDL in whole or in part), chronological and time-stamped (all parties know when a transaction was added to the ledger), consensus based (a transaction is added only if it is approved, typically unanimously, by parties on the network), verifiability (all transactions can be cryptographically verified). A blockchain is an example of a CDL. While the description and figures herein are described in terms of a blockchain, the instant application applies equally to any CDL.

A distributed ledger is a continuously growing list of records that typically apply cryptographic techniques such as storing cryptographic hashes relating to other blocks. A blockchain is one common instance of a distributed ledger and may be used as a public ledger to store information. Although, primarily used for financial transactions, a blockchain can store various information related to goods and services (i.e., products, packages, status, etc.). A decentralized scheme provides authority and trust to a decentralized network and enables its nodes to continuously and sequentially record their transactions on a public “block”, creating a unique “chain” referred to as a blockchain. Cryptography, via hash codes, is used to secure an authentication of a transaction source and removes a central intermediary. A blockchain is a distributed database that maintains a continuously-growing list of records in the blockchain blocks, which are secured from tampering and revision due to their immutable properties. Each block contains a timestamp and a link to a previous block. A blockchain can be used to hold, track, transfer and verify information. Since a blockchain is a distributed system, before adding a transaction to a blockchain ledger, all peers need to reach a consensus status.

Conventionally, proof of stake allocation models expose participants to unnecessary risk and encourage tokens and nodes to become concentrated in a small number of token holders rather than rewarding the most important nodes in blockchain networks. As such, what is needed is a more equitable allocation of tokens to nodes, especially in private or permissioned blockchain networks.

### SUMMARY

One example embodiment may provide a system that includes one or more of a user device, configured to submit a transaction, and a blockchain network. The blockchain network includes one or more validating nodes of a plurality of nodes, and coupled to the user device. In response to receiving the transaction, the blockchain network is configured to perform one or more of submit bids for validating the transaction from the one or more validating nodes, calculate transaction parameters based on the submitted bids, by the one or more validating nodes, validate, by the one or more validating nodes, the transaction, execute the transaction, calculate a chargeback for the transaction, and distribute the chargeback to at least one of the one or more validating nodes.

Another example embodiment may provide a method that includes one or more of receiving, by a blockchain network, a transaction from a user device, submitting bids for validating the transaction to nodes within the blockchain network, from one or more validating nodes, calculating transaction parameters based on the submitted bids, by the one or more validating nodes, validating, by the one or more validating nodes, the transaction, executing, by a node within the blockchain network, the transaction calculating a chargeback for the transaction, and distributing the chargeback to at least one of the one or more validating nodes.

A further example embodiment may provide a non-transitory computer readable medium comprising instructions, that when read by a processor, cause the processor to perform one or more of receiving, by a blockchain network, a transaction from a user device, submitting bids for validating the transaction to nodes within the blockchain network, from one or more validating nodes, calculating transaction parameters, by the one or more validating nodes, validating, by the one or more validating nodes, the transaction, executing, by a node within the blockchain network, the transaction, calculating a chargeback for the transaction, and distributing the chargeback to at least one of the one or more validating nodes.

### BRIEF DESCRIPTION OF THE DRAWINGS

FIG. 1A illustrates a network diagram of blockchain system, according to example embodiments.

FIG. 1B illustrates incentive mechanism calculations, according to example embodiments.

FIG. 2A illustrates an example peer node blockchain architecture configuration for an asset sharing scenario, according to example embodiments.

FIG. 2B illustrates an example peer node blockchain configuration, according to example embodiments.

FIG. 3 is a diagram illustrating a permissioned blockchain network, according to example embodiments.

FIG. 4 illustrates a system messaging diagram for performing transactions and chargebacks, according to example embodiments.

FIG. 5A illustrates a flow diagram of an example method of calculating and distributing transaction chargebacks in a blockchain, according to example embodiments.

FIG. 5B illustrates a flow diagram of an example method of funding transaction fees in a blockchain, according to example embodiments.

FIG. 6A illustrates an example physical infrastructure configured to perform various operations on the blockchain in accordance with one or more operations described herein, according to example embodiments.

FIG. 6B illustrates an example smart contract configuration among contracting parties and a mediating server configured to enforce smart contract terms on a blockchain, according to example embodiments.

FIG. 7 illustrates an example computer system configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

The instant application in one embodiment relates to blockchain networks, and more in another embodiment relates to providing equitable resource-based validation for transactions, on a distributed ledger (such as a blockchain).

Example embodiments provide methods, devices, networks and/or systems, which provide resource equity for blockchains. Although open, public blockchain networks such as Bitcoin first popularized the use of blockchain technology, private or permissioned blockchains have many promising applications within business networks. Blockchain networks are maintained by an established set of participants and an incentive structure is used to compensate those who operate the “nodes” of blockchain and validate transactions. For instance, one of the commonly used schemes is Proof of Stake. In Proof of Stake, stakeholders that hold supplies of a digital token get the ability to validate blockchain transactions, and are paid in additional tokens in return for their work. The problem is that consensus algorithms like Proof of Stake requires participants to hold a large supply of tokens that fluctuate in value, thus exposing participants to unnecessary risk. Because the rewards granted using Proof of Stake are proportional to the number of tokens held rather than the amount of work done, Proof of Stake encourages tokens and nodes to become concentrated in a handful of token holders, rather than encouraging distributed networks or rewarding the most important parties in the business network.

Likewise, there is a divide between cryptocurrency-based trust systems and non-cryptocurrency based trust systems, with each having their own merits. In a permissioned blockchain, adhering to an equitable model without the introduction of a cryptocurrency is a challenge. The present application addresses that challenge with an equitable compute equity model using an incentive mechanism to process transactions in permissioned blockchain networks.

Becoming a validating node for a blockchain network can be quite expensive and often requires the need for specialized hardware. The constant need for encryption and decryption may consume significant computational resources, which must be paid in electricity. The nature of a distributed ledger implies that all nodes must do the same amount of work, no matter how many transactions they submit to the ledger themselves. This creates a potential disadvantage where blockchain networks may have very few nodes in practice.

Public blockchains have incentives built into consensus to avoid these problems. Bitcoin and Ethereum use a Proof-of-Work system where ledgers are operated by third-party miners who perform calculations to verify the transactions to be incorporated into new blocks. In return, the validating nodes (miners) are rewarded with tokens embedded into the blocks they sign. These bounties reward them for the effort and encourages others to join the network. In Proof-of-Stake systems, the ledger is maintained by a set of stakeholders who own a digital currency, which gives them the ability to sign new blocks of transactions. In addition to protecting their investment (if the blockchain is worthless, their currency is too), stakeholders are rewarded for signing blocks with new coins. The reward is thus proportional to their holdings of the token or digital currency.

A blockchain is a distributed system which includes multiple nodes that communicate with each other. A blockchain operates programs called chaincode (e.g., smart contracts, etc.), holds state and ledger data, and executes transactions. Some transactions are operations invoked on the chaincode. In general, blockchain transactions typically must be “endorsed” by certain blockchain members and only endorsed transactions may be committed to the blockhcain and have an effect on the state of the blockchain. Other transactions which are not endorsed are disregarded. There may exist one or more special chaincodes for management functions and parameters, collectively called system chaincodes.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

A ledger is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain. There is typically one ledger per channel. Each peer node maintains a copy of the ledger for each channel of which they are a member.

A chain is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

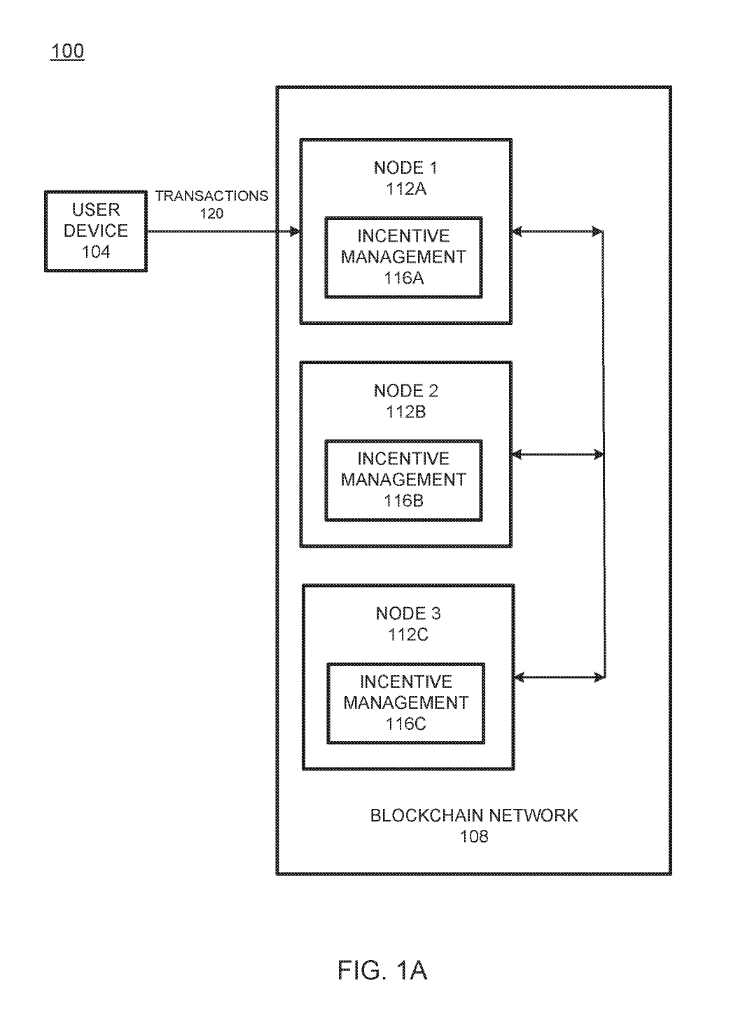

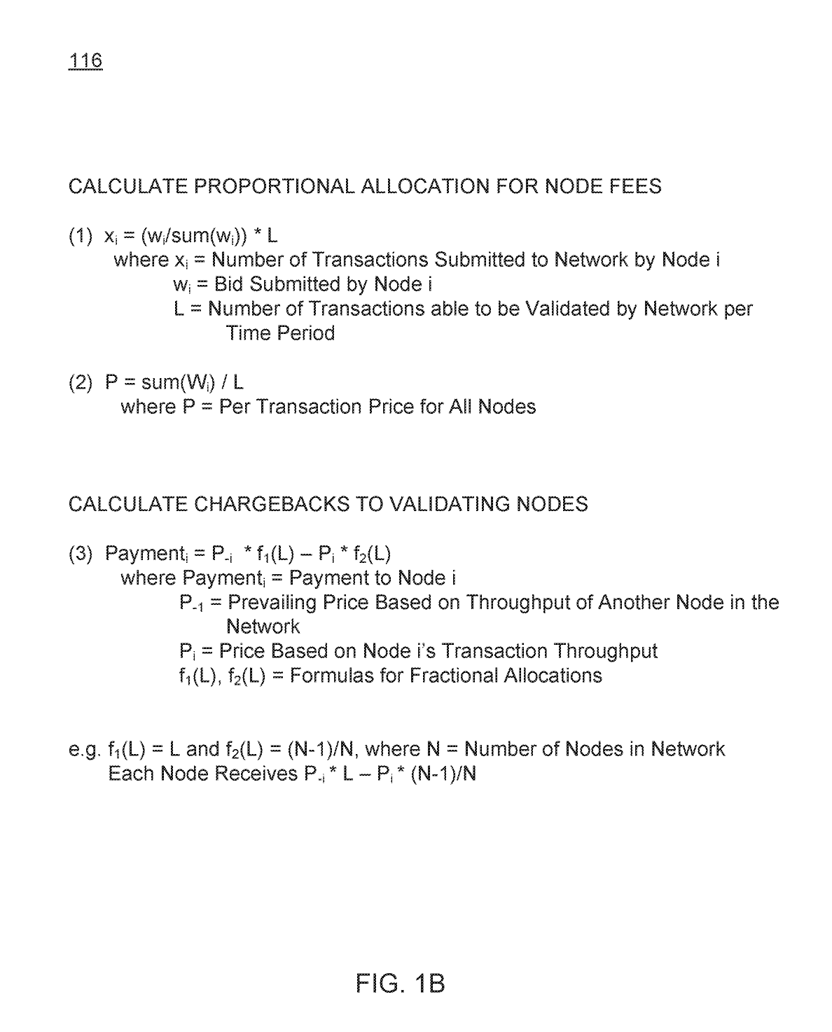

FIG. 1A illustrates a network diagram of a blockchain system, according to example embodiments. Referring to FIG. 1A, the blockchain system 100 includes one or more user devices 104. User device 104 is a computer that generates transactions 120 for a user associated with the user device 104. Transactions 120 may be any transaction processed by a blockchain network 108, including but not limited to purchase transactions for goods or services, transfer of documents or records, recording or notification of events, and voting-related information. The blockchain system 100 includes a blockchain network 108, which processes transactions on behalf of users. In the preferred embodiment, blockchain network 108 is a private or permissioned blockchain network 108. However, the blockchain network 108 may also be a public blockchain network 108.

The blockchain network 108 includes blockchain nodes 112A, 112B, 112C, which receive and process transactions 120 and manage all activities associated with the blockchain network 108. FIG. 1A illustrates a blockchain network 108 including three blockchain nodes 112, identified as blockchain node 1 112A, node 2 112B, and node 3 112C. Although three nodes 112 are illustrated, it should be understood there may be any number of nodes 112 in blockchain network 108. At least one node 112 includes an incentive management function 116, identified as 116A, 116B, and 116C, which calculates and manages transaction parameters and compensation for transaction validation within blockchain system 100. In some embodiments all nodes 112 or a majority of nodes 112 of blockchain system 108 include an incentive management function 116. In the illustrated embodiment, each of nodes 1-3 112A-112C includes an incentive management function 116A-116C, respectively. Node 1 112A receives the transaction 120, and submits the transaction 120 to the blockchain network 108 (i.e. node 1 112A is a committer).

The incentive management function 116 allows the blockchain network 108 to overcome the shortcomings of cryptocurrency-based trust systems like Proof of Stake or Proof of Work by developing an incentive process that rewards participants based on the work of validating transactions 120 rather than owning tokens. The new process establishes a price per transaction over which no node 112 in the blockchain network 108 has control, and incentivizes all nodes 112 to validate as many transactions 120 as possible. The mechanism achieves this by charging users a per-transaction fee, the price of which is determined by bids submitted by nodes 112 to a proportional allocation auction mechanism calculated within the incentive management function(s) 116. The proportional allocation mechanism provides competing bidders (nodes 112) access to a fixed resource (e.g. computing resources, memory) in proportion to their bid relative to the total amount bid by all bidding nodes 112.

The transaction fees (and assumption of transaction costs) are then distributed to the nodes 112 that participate in consensus using a formula that incentivizes nodes 112 to maximize how quickly they validate transactions. The process does not allow nodes 112 to implicitly influence the price of transactions by slowing the number of validated transactions and driving up the price. The process also discourages nodes 112 from operating the blockchain on cheaper hardware and forcing the costs of slower transaction speeds on the rest of the blockchain network 108.

The process may also be applied to assigning the transaction roles such as endorsers, orderers and committers—where the allocation can depend on the service provided to the blockchain network 108. Nodes 112 who do not wish to allocate compute resources can simply pay a fee to process transactions. Furthermore, a fee ledger 430 may be maintained between nodes 112 to provide for fee netting and reconciliation—giving a node 112 operator an avenue for a fair and just chargeback system—as opposed to the flat and inequitable models that exist today. The fee ledger 430 may either be within the incentive management functions 116, or may be uniquely assigned to a trusted node 112 within the blockchain network 108.

FIG. 1B illustrates incentive mechanism calculations, according to example embodiments. Referring to FIG. 1B, in response to receiving bids from all nodes wishing to participate in transaction validation, the incentive management function(s) calculate transaction parameters 415. The incentive management function 116 allocates each participating node 112 a fixed number of transactions within a given time period based on the bid that node 112 submits to the blockchain network 108. The time period is arbitrary and predetermined, and may be any length of time as long as the same time period is used for each participating node 112. First, the incentive management function 116 determines the number of transactions the blockchain network 108 can validate per time period by all nodes 112. This is assigned the value L in equation (1). Validated transactions 120 are added to the blockchain ledger. Once all the bids have been received, the incentive management function 116 calculates a number of transactions submitted to the blockchain network 108 by each participating node i 112. Each node i 112 submits bid wᵢ, so that all participating nodes 112 submit bids equal to sum(wᵢ). and receives ability to submit xᵢ transactions to the network. Then, the incentive management function 116 calculates xᵢ for each participating node 112 as:

xᵢ=(wᵢ/sum(wᵢ))*L (1)

For example, assuming that L=10 validated transactions in a time period (1 minute), wᵢ=a bid of $1 for node i 112, and sum(wᵢ)=$10, xᵢ=(1/10)*10, and 1 transaction may be submitted to the blockchain network each minute by node i.

Next, the incentive management function 116 uses equation (2) to calculate a transaction price P for all participating nodes i 112. The incentive management function 116 calculates P as:

P=sum(Wᵢ)/L (2)

Using the same parameters as the current example, P=$10/10=$1 transaction price (fee). The transaction price P is the same for all participating nodes i 112. Advantageously, the transaction price P for this process is determined entirely by demand, rather than by a token price or a fee established by a consortium of nodes 112.

After the transaction price P has been determined, the revenue from bids can then be allocated to validating nodes 112 via chargebacks. The chargebacks can be administered by a central authority, or by a distributed algorithm that all parties agree to before instantiating the blockchain network 108. Although FIG. 1B only illustrates nodes 112 including the incentive management function 116, it should be understood that in other embodiments the central authority or trusted entity performs the chargeback calculation instead of the nodes 112. Because the throughput of a blockchain network 108 is the speed of its slowest node 112, it is important that the chargeback formula not give slow nodes 112 pricing power.

The blockchain network 108 receives total revenue of P*L. For the current example, the total revenue would be P*L=$1*10=$10. Each participating node 112 is allocated a fraction of the total number of transactions according to a formula f(L). The formulas f₁ and f₂ actually used may be application dependent, and different parameters will yield different payment allocation to each participating node 112. Nodes 112 operated by parties that receive transactions, for example being sent money or a shipment, can be subsidized by chargebacks so that those parties join the blockchain network 108. For example, a shipping network may want large ports to join its blockchain network 108. As another example, large parties that receive transactions subsidize smaller parties sending them transactions such as a large retailer subsidizing its suppliers. Each node i 112 would receive payment according to the following calculation (3):

Paymentᵢ=P₋ᵢ*f₁(L)−Pᵢ*f₂(L) (3)

P−ᵢ is the price that would prevail based on the throughput of another (different) node 112 in the blockchain network 108, and Pᵢ is the price based on node i's transaction throughput. P−_{I} indicates the transaction price based on the throughput of any other participating node 112 in the blockchain network 108, aside from node i 112. Therefore, for a blockchain network 108 with 4 participating nodes 112, and if the current node i happens to be node 3, P₋₃ means the transaction price calculated using the transaction price from the throughput of nodes 1, 2, or 4 (i.e. “the throughput of another node 112 in the blockchain network 108”).

The price that would prevail is the transaction price with the throughput of another node 112 in the blockchain network 108. Which other node 112 is used in the calculation can vary, depending on the formula, but the formula is applicable for any other nodes 112 picked. This formula is effective because throughput of each node 112 only effects their payment through the second penalty term. As a result, each node's payment is increasing in the number of transactions they process, encouraging nodes 112 to maximize throughput and invest in efficient hardware to validate transactions. For example, assuming f₁=L=10 and f₂=(N−1)/N, where N=the number of participating nodes 112 and N=4 and f₂=(N−1)/N=(4−1)/4=3/4. Then each node receives L/N discounted by the penalty for falling behind the throughput of other nodes 112. If −i is set based on nodes 112 that are faster than node i 112 (such as the fastest node 112, for instance), then payments will not exceed revenue. The formula can also be customized to depend on the flow of transactions 120, as to encourage the most important participating nodes 112 (those that receive the most transactions 120) to become validating nodes 112. This option offers another advantage over Proof of Stake protocols, where nodes are operated by those with enough tokens to earn a positive return on investment. Nodes 112 are rewarded for participating in the blockchain network 108 and dedicating enough resources to enhance the running of the blockchain network 108 by processing transactions quickly. In contrast, Proof of Stake networks reward owning tokens, which is not a useful activity for operating a blockchain network and has no relationship to hosting resources.

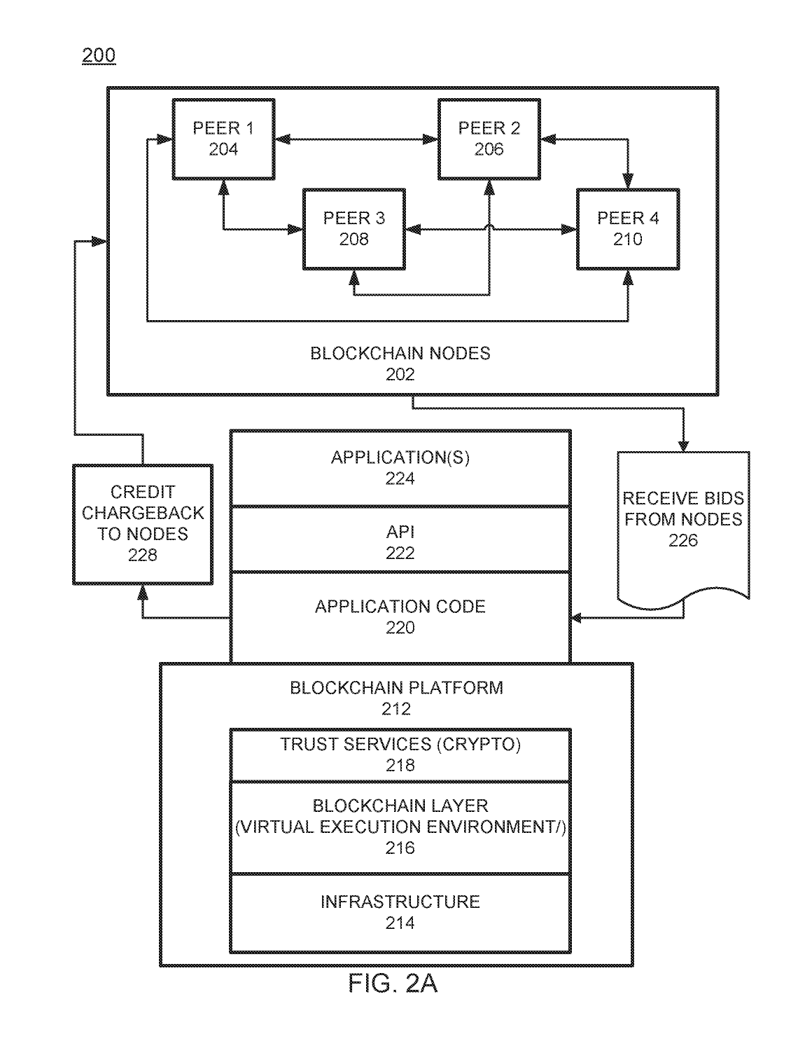

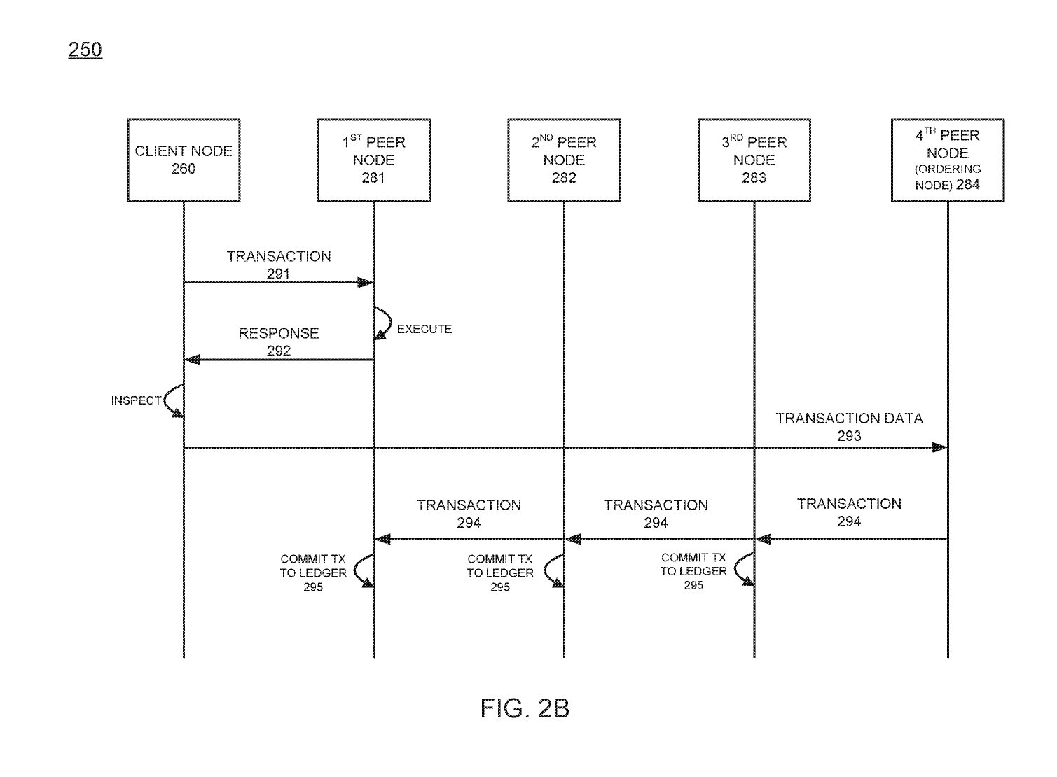

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (four nodes are depicted by example only). These nodes participate in a number of activities, such as blockchain transaction addition and validation process (consensus). One or more of the blockchain nodes 204-210 may endorse transactions and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services 218, virtual execution environment 216, etc.), and underpinning physical computer infrastructure 214 that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The application code 220 may control blockchain assets. For example, the application code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, bids from nodes may be processed by one or more processing entities (e.g., virtual machines) included in the blockchain layer 216. The application code 220 may then calculate a transaction price (not shown) and chargebacks to validating nodes 228. The physical infrastructure 214 may be utilized to retrieve any of the data or information described herein.

Within chaincode, a smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details. In FIG. 2A, the blockchain platform 212, which includes incentive management 116, receives bids from the blockchain nodes 226 that elect to bid on transactions. One function may be to credit chargeback to nodes 228, which may be provided to one or more of the nodes 204-210.

FIG. 2B illustrates an example of a transactional flow 250 between nodes of the blockchain in accordance with an example embodiment. Referring to FIG. 2B, the transaction flow may include a transaction proposal 291 sent by an application client node 260 or client device to an endorsing peer node 281. The endorsing peer node 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client node 260 along with an endorsement signature, if approved. The client node 260 assembles the endorsements into a transaction payload 293 and broadcasts it to an ordering service node 284. The ordering service node 284 then delivers ordered transactions as blocks to all peer nodes 281-283 on a channel. Before committal to the blockchain, each peer node 281-283 may validate the transaction. For example, the peer nodes may check the endorsement policy to ensure that the correct allotment of the specified peer nodes have signed the results and authenticated the signatures against the transaction payload 293.

Referring again to FIG. 2B, the client node 260 initiates the transaction 291 by constructing and sending a request to the peer node 281, which is an endorser. The client node 260 may include an application leveraging a supported software development kit (SDK), such as NODE, JAVA, PYTHON, and the like, which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client node 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In proposal response 292, the set of values, along with the endorsing peer node's 281 signature is passed back as a proposal response 292 to the SDK of the client node 260 which parses the payload for the application to consume.

In response, the application of the client node 260 inspects/verifies the endorsing peers signatures and compares the proposal responses to determine if the proposal response 292 is the same. If the chaincode only queried the ledger, the application would inspect the query response and would typically not submit the transaction to the ordering service node 284. If the client application intends to submit the transaction 291 to the ordering service node 284 to update the ledger, the application determines if the specified endorsement policy has been fulfilled before submitting (i.e., did all peer nodes necessary for the transaction 291 endorse the transaction?). Here, the client node 260 may include only one of multiple parties to the transaction. In this case, each client node 260 may have their own endorsing node, and each endorsing node will need to endorse the transaction. The architecture is such that even if an application selects not to inspect responses 292 or otherwise forwards an unendorsed transaction, the endorsement policy will still be enforced by peer nodes 281-283 and upheld at the commit validation phase.

After successful inspection, in step 293 the client node 260 assembles endorsements into a transaction and broadcasts the transaction proposal and response within a transaction message 293 to the ordering node 284. The transaction 293 may contain the read/write sets, the endorsing peers signatures and a channel ID. The ordering node 284 does not need to inspect the entire content of a transaction 293 in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block 294 are tagged as being valid or invalid. Furthermore, in step 295 each peer node 281-283 appends the block to the channel's chain, and for each valid transaction 294 the write sets are committed to current state database. An event is emitted in order to to notify the client application that the transaction (invocation) has been immutably appended to the chain, as well as to notify whether the transaction 294 was validated or invalidated.

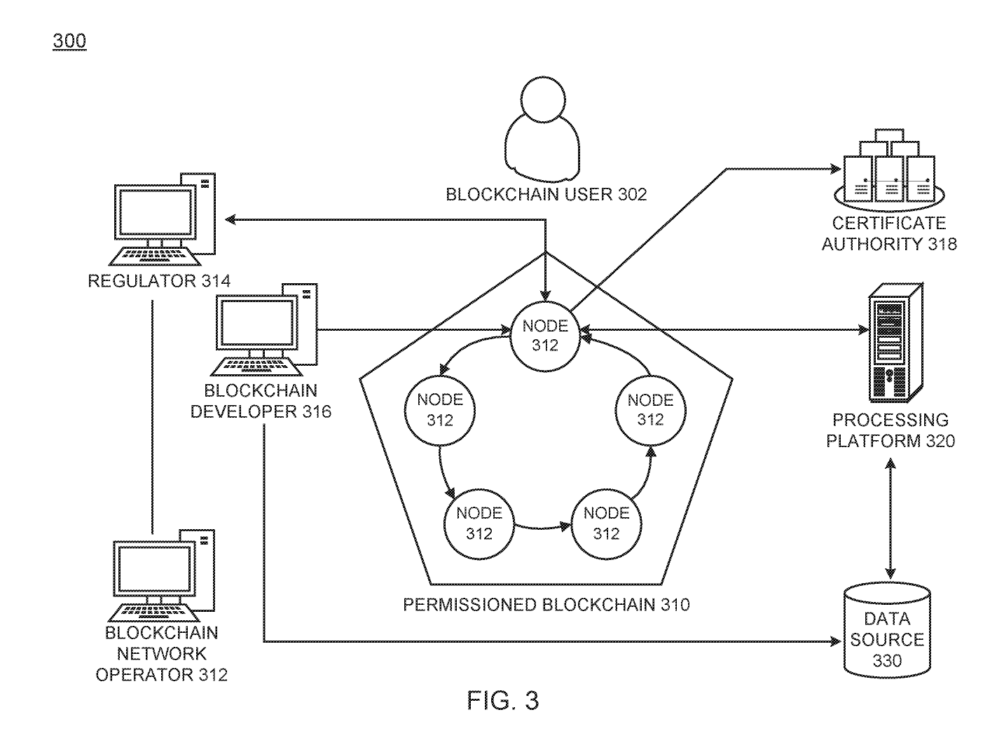

FIG. 3 illustrates an example of a permissioned blockchain network 300, which features a distributed, decentralized peer-to-peer architecture, and a certificate authority 318 managing user roles and permissions. In this example, the blockchain user 302 may submit a transaction to the permissioned blockchain network 310. In this example, the transaction can be a deploy, invoke or query, and may be issued through a client-side application leveraging an SDK, directly through a REST API, or the like. Trusted business networks may provide access to regulator systems 314, such as auditors (the Securities and Exchange Commission in a U.S. equities market, for example). Meanwhile, a blockchain network operator system of nodes 312 manages member permissions, such as enrolling the regulator system 314 as an “auditor” and the blockchain user 302 as a “client.” An auditor could be restricted only to querying the ledger whereas a client could be authorized to deploy, invoke, and query certain types of chaincode.

A blockchain developer system 316 writes chaincode and client-side applications. The blockchain developer system 316 can deploy chaincode directly to the network through a REST interface. To include credentials from a traditional data source 330 in chaincode, the developer system 316 could use an out-of-band connection to access the data. In this example, the blockchain user 302 connects to the network through a peer node 312. Before proceeding with any transactions, the peer node 312 retrieves the user's enrollment and transaction certificates from the certificate authority 318. In some cases, blockchain users 302 must possess these digital certificates in order to transact on the permissioned blockchain network 310. Meanwhile, a blockchain user 302 attempting to drive chaincode may be required to verify their credentials on the traditional data source 330. To confirm the user's authorization, chaincode can use an out-of-band connection to this data through a traditional processing platform 320.

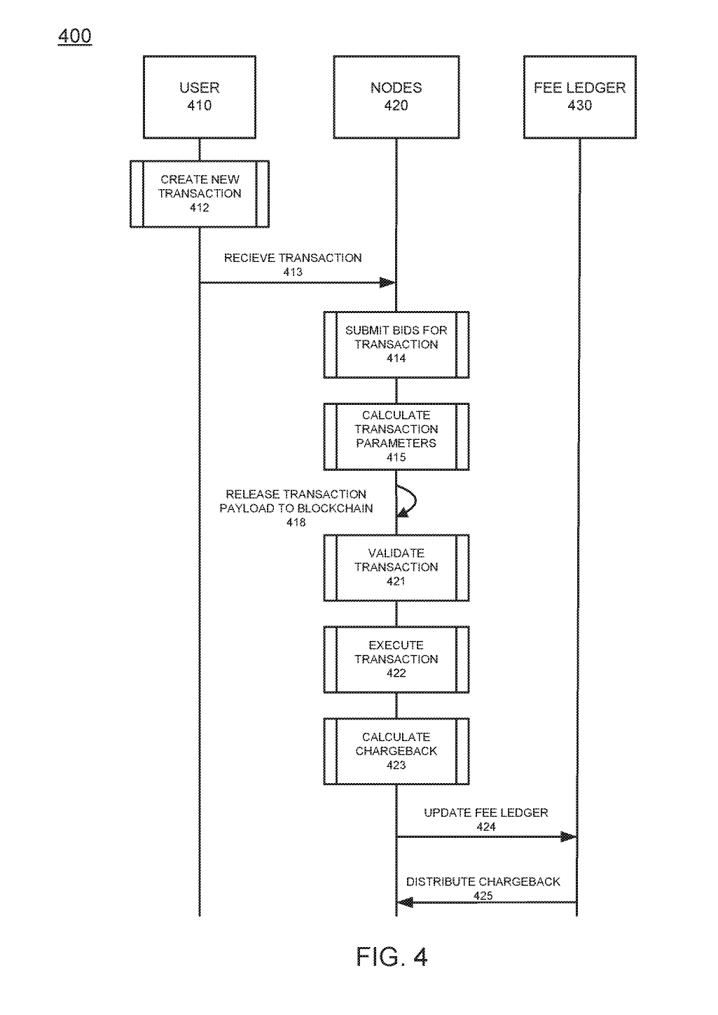

FIG. 4 illustrates a system messaging diagram for performing transactions and chargebacks, according to example embodiments. Referring to FIG. 4, the system diagram 400 includes one or more users 410, one or more blockchain nodes 420, and a fee ledger 430. The one or more users 410 create new transactions 412 to a blockchain network 108, which includes nodes 420. A node 420 receives the transaction 413, and notifies other nodes 420 of the received transaction 413. In response, the nodes 420 that wish to participate in a validation bidding process submit bids 414 to the nodes 420 of the blockchain network 108. The nodes calculate transaction parameters 415, as described with reference to FIG. 1B. In preparation for executing the transaction 412, the nodes 420 release the transaction payload to the blockchain 418. The nodes 420 that submitted bids for the transaction 414 then validate the transaction 421. The nodes 420 that validate the transaction 421 add the validated transaction to their copy of the distributed ledger (not shown). It should be noted that validating nodes 420 do not need to submit a bid or transactions in order to validate transactions.

Depending on the type of transaction 412, once the transaction has been validated 421 a node 420 executes the transaction 422 based on the transaction payload 418. In one embodiment, each of the nodes 420 involved in the bidding process then calculates chargebacks 423 to one or more nodes 420, depending on the results of the calculations shown in FIG. 1B. In another embodiment, a trusted entity within the blockchain network (which may be a node 420) calculates chargebacks 423 to one or more nodes 420. The nodes 420 then update a fee ledger 424, and the trusted entity responsible for the fee ledger distributes chargebacks 425 to one or more nodes 420 at a predetermined time (i.e. at the end of a day, week, month, quarter, etc). This may advantageously allow fees to flow through the blockchain network 108 without constant interruptions and accompanying cost.

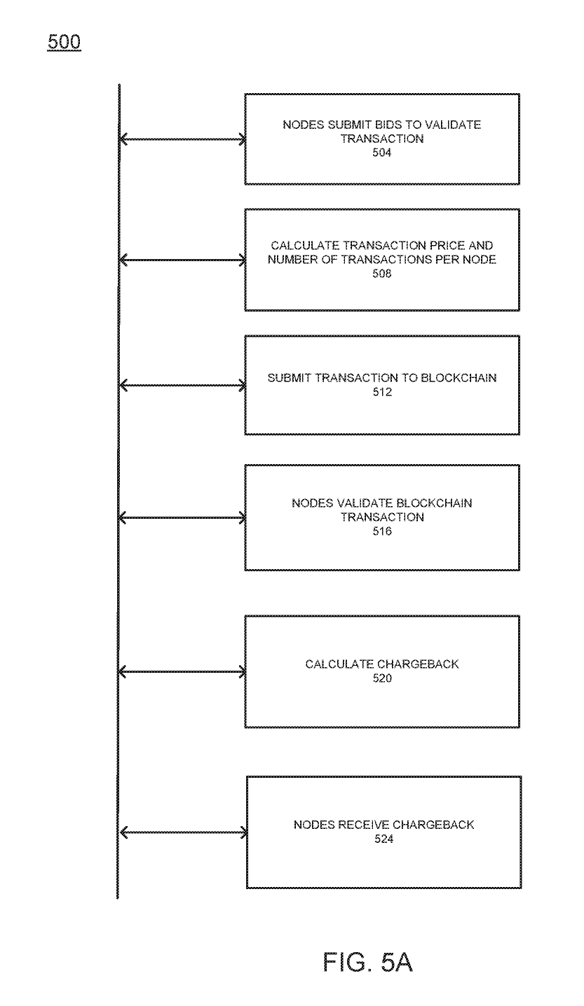

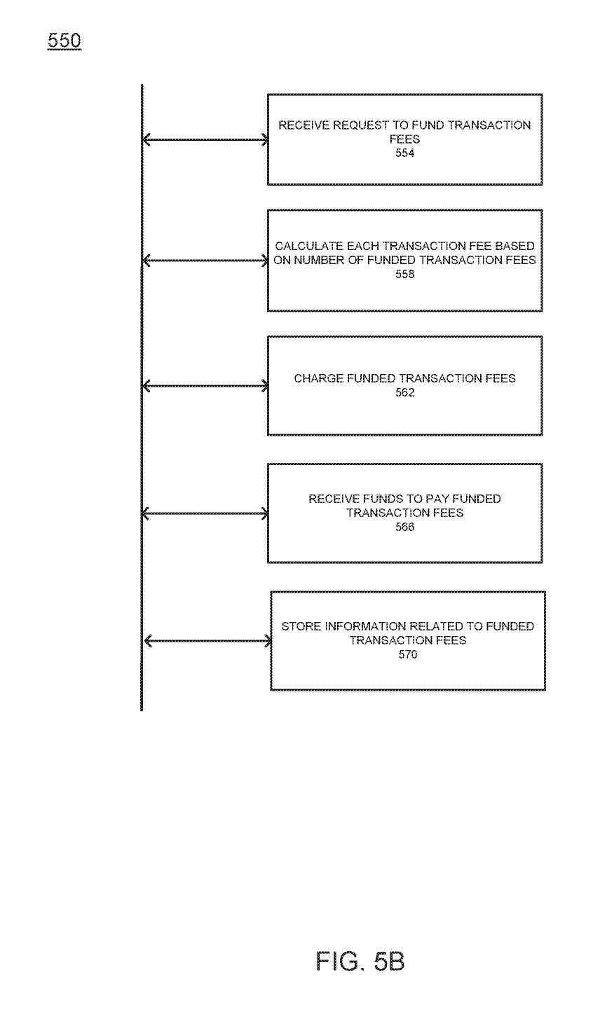

FIG. 5A illustrates a flow diagram 500 of an example method of calculating and distributing transaction chargebacks in a blockchain, according to example embodiments. Referring to FIG. 5A, the method 500 may include nodes submitting bids to validate a transaction 504. Less than all nodes 420 may submit bids, and at least one node 420 submits a bid. The method 500 may also include a step of calculating a transaction price and a number of transactions per node 508. These calculations may take many forms, and FIG. 1 illustrates a possible series of calculations. The method 500 may also include a step of submitting the transaction to the blockchain 512, in preparation for validating the transaction. The method 500 may also include a step of nodes validating the blockchain transaction 516. The steps of validating a transaction are well understood in blockchain technology. The method 500 may also include a step of calculating a chargeback 520. This is also represented in the example of FIG. 1B, and is an amount paid to nodes 420 that validated the transaction. Finally, the method 500 may also include a step of the nodes 420 receiving a chargeback 524 as compensation for validating the transaction. Finally, the method 500 may also include charging a transaction fee to a node or client device that submitted the transaction (not shown).

FIG. 5B illustrates a flow diagram 550 of an example method of calculating transaction fees, according to example embodiments. The method 550 may include receiving a request to fund transaction fees 445. The method 550 may also include a step of calculating each transaction fee based on a number of funded transaction fees 558. The method 550 may also include a step of charging funded transaction fees 562. The method 550 may also include a step of receiving funds to pay funded transaction fees 566. The method 550 may also include a step of storing information related to funded transaction fees 570.

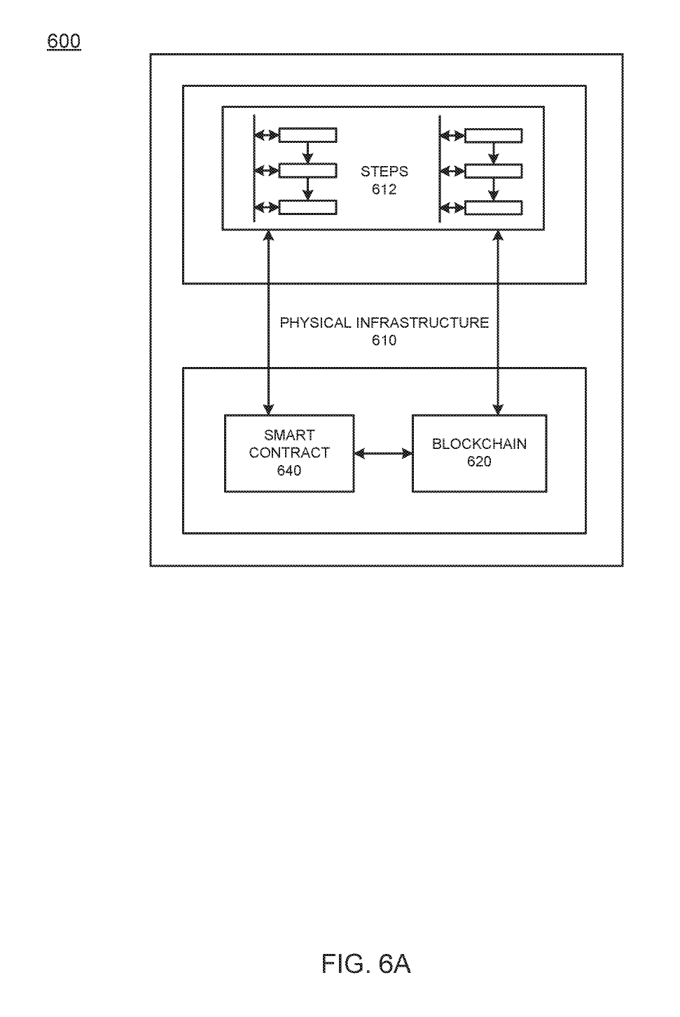

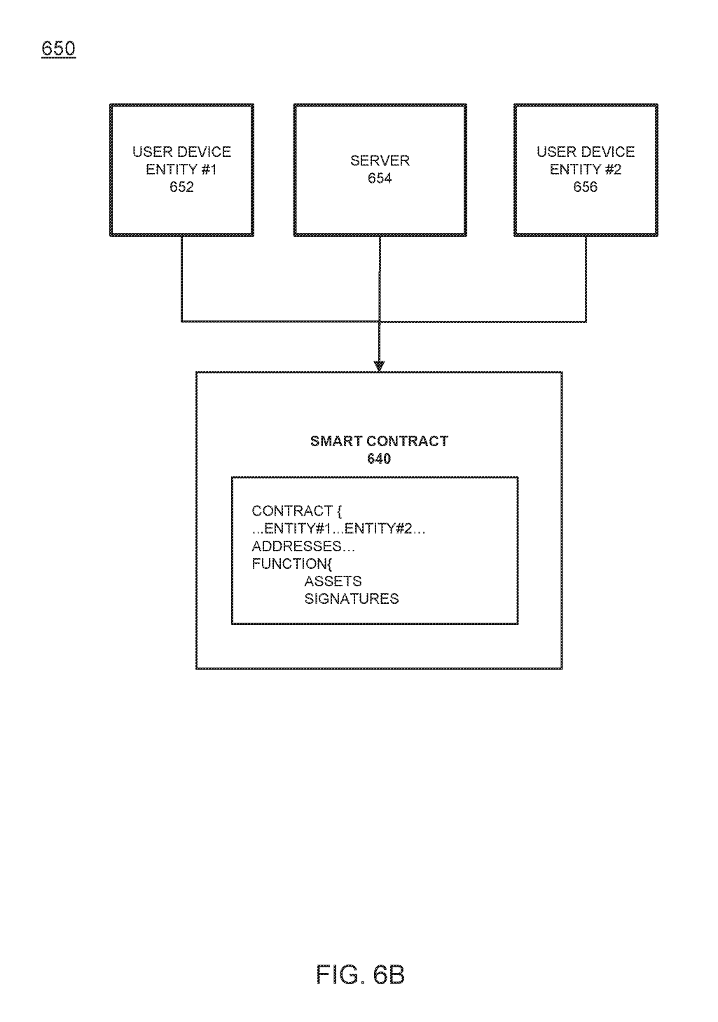

FIG. 6A illustrates an example physical infrastructure configured to perform various operations on the blockchain in accordance with one or more of the example methods of operation according to example embodiments. Referring to FIG. 6A, the example configuration 600 includes a physical infrastructure 610 with a blockchain 620 and a smart contract 640, which may execute any of the operational steps 612 included in any of the example embodiments. The steps/operations 612 may include one or more of the steps described or depicted in one or more flow diagrams and/or logic diagrams. The steps may represent output or written information that is written or read from one or more smart contracts 640 and/or blockchains 620 that reside on the physical infrastructure 610 of a computer system configuration. The data can be output from an executed smart contract 640 and/or blockchain 620. The physical infrastructure 610 may include one or more computers, servers, processors, memories, and/or wireless communication devices.

FIG. 6B illustrates an example smart contract configuration among contracting parties and a mediating server configured to enforce the smart contract terms on the blockchain according to example embodiments. Referring to FIG. 6B, the configuration 650 may represent a communication session, an asset transfer session or a process or procedure that is driven by a smart contract 640 which explicitly identifies one or more user devices 652 and/or 656. The execution, operations and results of the smart contract execution may be managed by a server 654. Content of the smart contract 640 may require digital signatures by one or more of the entities 652 and 656, which are parties to the smart contract transaction. The results of the smart contract 640 execution may be written to a blockchain as a blockchain transaction.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

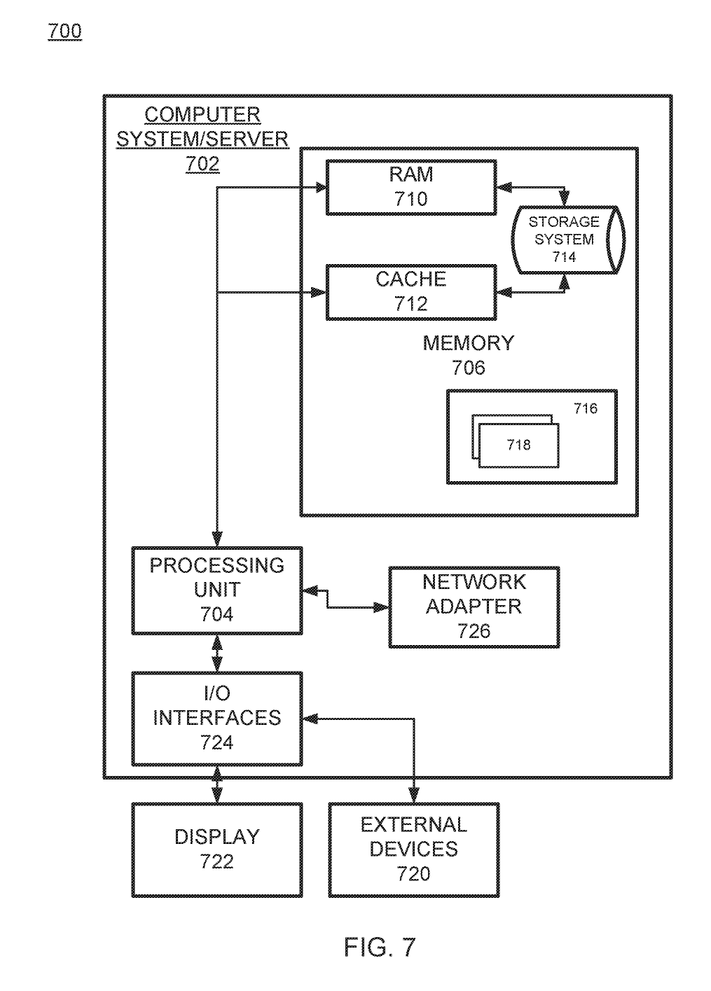

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 7 illustrates an example computer system architecture 700, which may represent or be integrated in any of the above-described components, etc.

FIG. 7 is not intended to suggest any limitation as to the scope of use or functionality of embodiments of the application described herein. Regardless, the computing node 700 is capable of being implemented and/or performing any of the functionality set forth hereinabove. In computing node 700, there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one embodiment, implements the flow diagrams of the other figures. The system memory 706 can include computer system readable media in the form of volatile memory, such as random-access memory (RAM) 710 and/or cache memory 712. Computer system/server 702 may further include other removable/non-removable, volatile/non-volatile computer system storage media. By way of example only, storage system 714 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 706 may include at least one program product having a set (e.g., at least one) of program modules that are configured to carry out the functions of various embodiments of the application.

Program/utility 716, having a set (at least one) of program modules 718, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present application may take the form of a computer program product embodied in one or more computer readable medium(s) having computer readable program code embodied thereon.

Computer system/server 702 may also communicate with one or more external devices 720 such as a keyboard, a pointing device, a display 722, etc.; one or more devices that enable a user to interact with computer system/server 702; and/or any devices (e.g., network card, modem, etc.) that enable computer system/server 702 to communicate with one or more other computing devices. Such communication can occur via I/O interfaces 724. Still yet, computer system/server 702 can communicate with one or more networks such as a local area network (LAN), a general wide area network (WAN), and/or a public network (e.g., the Internet) via network adapter 726. As depicted, network adapter 726 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A system, comprising:
a user device, configured to submit a transaction;
a blockchain network, comprising one or more validating nodes of a plurality of nodes and coupled to the user device, in response to a receipt of the transaction, configured to:
submit bids for validating the transaction from the one or more validating nodes;
calculate transaction parameters based on the submitted bids, by the one or more validating nodes;
validate, by the one or more validating nodes, the transaction;
execute the transaction;
calculate a chargeback for the transaction; and
distribute the chargeback to at least one of the one or more validating nodes.

2. The system of claim 1, wherein the blockchain network is a permissioned blockchain network.

3. The system of claim 2, wherein the blockchain network charges the user device a transaction fee based on the transaction parameters.

4. The system of claim 3, wherein the transaction fee is based on a sum of submitted bids and a quantity of transactions able to be validated by the blockchain network within a predetermined time period.

5. The system of claim 1, wherein the blockchain network calculates the chargeback for each of the one or more validating nodes, wherein the chargeback to a given validating node is based on a combination of a price based on a throughput of a different validating node and a price based on a throughput of the given validating node.

6. The system of claim 5, wherein the chargeback to the given validating node is additionally based on a fractional allocation to each of the given validating node and the different validating node, the fractional allocation based on a total number of nodes in the blockchain network.

7. The system of claim 5, wherein the different validating node is a node of the blockchain network that validates the transaction faster than any other validating node, other than the given validating node.

8. A method, comprising:
receiving, by a blockchain network, a transaction from a user device;
submitting bids for validating the transaction to nodes within the blockchain network, from one or more validating nodes;
calculating transaction parameters based on the submitted bids, by the one or more validating nodes;
validating, by the one or more validating nodes, the transaction;
executing, by a node within the blockchain network, the transaction;
calculating a chargeback for the transaction; and
distributing the chargeback to at least one of the one or more validating nodes.

9. The method of claim 8, wherein the blockchain network is a permissioned blockchain network.

10. The method of claim 9, wherein the blockchain network charges the user device a transaction fee based on the transaction parameters.

11. The method of claim 10, wherein the transaction fee is based on a sum of submitted bids and a quantity of transactions able to be validated by the blockchain network within a predetermined time period.

12. The method of claim 8, wherein the blockchain network calculates the chargeback for each of the one or more validating nodes, wherein the chargeback to a given validating node is based on a combination of a price based on a throughput of a different validating node and a price based on a throughput of the given validating node.

13. The method of claim 12, wherein the chargeback to the given validating node is also based on a fractional allocation to each of the given validating node and the different validating node, the fractional allocation based on a total number of nodes in the blockchain network.

14. The method of claim 12, wherein the different validating node is a node of the blockchain network that validates the transaction faster than any other validating node, other than the given validating node.

15. A non-transitory computer readable medium comprising instructions, that when read by a processor, cause the processor to perform:
receiving, by a blockchain network, a transaction from a user device;
submitting bids for validating the transaction to nodes within the blockchain network, from one or more validating nodes;
calculating transaction parameters, by the one or more validating nodes;
validating, by the one or more validating nodes, the transaction;
executing, by a node within the blockchain network, the transaction;
calculating a chargeback for the transaction; and
distributing the chargeback to at least one of the one or more validating nodes.

16. The non-transitory computer readable medium of claim 15, wherein the blockchain network is a permissioned blockchain network.

17. The non-transitory computer readable medium of claim 15, wherein the blockchain network charges the user device a transaction fee based on the transaction parameters.

18. The non-transitory computer readable medium of claim 15, wherein the transaction fee is based on a sum of submitted bids and a quantity of transactions able to be validated by the blockchain network within a predetermined time period.

19. The non-transitory computer readable medium of claim 15, wherein the blockchain network calculates the chargeback for each of the one or more validating nodes, wherein the chargeback to a given validating node is based on a combination of a price based on a throughput of a different validating node and a price based on a throughput of the given validating node.

20. The non-transitory computer readable medium of claim 19, wherein the chargeback to the given validating node is also based on a fractional allocation to each of the given validating node and the different validating node, the fractional allocation based on a total number of nodes in the blockchain network.
